(19) United States
(12) Patent Application Publication
(10) Pub. No.: US 2025/0363762 A1
(43) Pub. Date: Nov. 27, 2025

(54) METHOD AND APPARATUS FOR INTERACTION IN VIRTUAL SCENE, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventor: Tianchi YANG, Shenzhen (CN)

(21) Appl. No.: 19/295,278

(22) Filed: Aug. 8, 2025

Related U.S. Application Data
(63) Continuation of application No. PCT/CN2024/085558, filed on Apr. 2, 2024.

(30) Foreign Application Priority Data
May 31, 2023 (CN) 202310636230.6

(51) Int. Cl. G06T 19/20; A63F 13/56; A63F 13/69; G06T 19/00

(52) U.S. Cl. CPC G06T 19/20; A63F 13/56; A63F 13/69; G06T 19/003; G06T 2219/2004

(57) ABSTRACT

This application provides a method for interaction in a virtual scene performed by a computer device. The method includes: displaying, at a first location in a second virtual space, a virtual object teleported from a first virtual space to the second virtual space, wherein the first location is different from a location of an exit of the first terrain; teleporting the virtual object back to the first virtual space when the virtual object moves from the first location to the exit of the first terrain; changing a terrain in the second virtual space from the first terrain to a second terrain when the virtual object is teleported from the first virtual space to the second virtual space again; and displaying the virtual object at a second location in the second terrain, the second location being different from a location of an exit of the second terrain.

### CROSS-REFERENCE TO RELATED APPLICATIONS

This application is a continuation application of PCT Patent Application No. PCT/CN2024/085558, entitled “METHOD AND APPARATUS FOR INTERACTION IN VIRTUAL SCENE, ELECTRONIC DEVICE, COMPUTER-READABLE STORAGE MEDIUM, AND COMPUTER PROGRAM PRODUCT” filed on Apr. 2, 2024, which claim priority to Chinese Patent Application No. 202310636230.6, entitled “METHOD AND APPARATUS FOR INTERACTION IN VIRTUAL SCENE, ELECTRONIC DEVICE, COMPUTER-READABLE STORAGE MEDIUM, AND COMPUTER PROGRAM PRODUCT” filed on May 31, 2023, both of which are hereby incorporated by reference in their entirety.

### FIELD OF THE TECHNOLOGY

This application relates to the field of virtualization and human-computer interaction technologies, and in particular, to a method and an apparatus for interaction in a virtual scene, an electronic device, a non-transitory computer-readable storage medium, and a computer program product.

### BACKGROUND OF THE DISCLOSURE

In the related art, designing a terrain in a game scene costs a large quantity of planning and art resources. Therefore, to save resources, many games may be designed with fixed maps or terrains for a same game scene. However, interaction of players only in the fixed maps or terrains results in a single interaction process of the players. Consequently, efficiency of human-computer interaction is excessively low, and hardware processing resources are wasted.

### SUMMARY

Embodiments of this application provide a method and an apparatus for interaction in a virtual scene, an electronic device, a non-transitory computer-readable storage medium, and a computer program product, to improve diversity of an interaction mode, efficiency of human-computer interaction, and utilization of hardware processing resources in a virtual scene.

Technical solutions of the embodiments of this application are implemented as follows.

An embodiment of this application provides a method for interaction in a virtual scene performed by a computer device and the method includes:
displaying, at a first location in a second virtual space, a virtual object teleported from a first virtual space to the second virtual space, wherein the first location is in a first terrain of the second virtual space and the first location is different from a location of an exit of the first terrain;
teleporting the virtual object back to the first virtual space when the virtual object moves from the first location to the exit of the first terrain;
changing a terrain in the second virtual space from the first terrain to a second terrain when the virtual object is teleported from the first virtual space to the second virtual space again; and
displaying the virtual object at a second location in the second terrain, the second location being different from a location of an exit of the second terrain.

An embodiment of this application provides a computer device, including:
a memory, configured to store computer-executable instructions; and
a processor, configured to implement the method for interaction a virtual scene according to the embodiments of this application when executing the computer-executable instructions stored in the memory.

An embodiment of this application provides a non-transitory computer-readable storage medium, having computer-executable instructions stored therein. The computer-executable instructions, when executed by a processor, implement the method for interaction in a virtual scene according to the embodiments of this application.

The embodiments of this application have the following beneficial effects.

In the foregoing embodiments of this application, the virtual object is teleported from the first virtual space in the virtual scene to the first location different from the exit in the second virtual space. The second virtual space has the first terrain, and the first location is in the first terrain. The virtual object is teleported back to the first virtual space when the virtual object moves from the first location to the exit of the first terrain. When the virtual object is teleported from the first virtual space to the second virtual space again, the terrain in the second virtual space is controlled to change from the first terrain to the second terrain, and the virtual object is displayed at the second location different from the location of the exit in the second terrain. In this way, when the virtual object is teleported to the second virtual space for the first time, the virtual object is teleported to the first terrain that the second virtual space has, and after the virtual object leaves the second virtual space, when the virtual object is teleported to the second virtual space again, the terrain in the second virtual space is controlled to change from the first terrain to the second terrain, so that the virtual object is teleported to the second terrain that the second virtual space has. In this way, each time the virtual object is teleported to the second virtual space, the terrain that the second virtual space has is dynamically changed. Compared with teleporting the virtual object to a fixed terrain each time, this improves utilization of terrain resources in the virtual scene, thereby improving efficiency of human-computer interaction and utilization of hardware resources of the electronic device.

### BRIEF DESCRIPTION OF THE DRAWINGS

FIG. 1 is a schematic diagram of an architecture of a system 100 for interaction in a virtual scene according to an embodiment of this application.

FIG. 2 is a schematic structural diagram of an electronic device according to an embodiment of this application.

FIG. 3 is a schematic flowchart of a method for interaction in a virtual scene according to an embodiment of this application.

FIG. 4 is a schematic diagram of a second virtual space when a first location is an entrance of a first terrain according to an embodiment of this application.

FIG. 5 is a schematic diagram of a second virtual space when a first location is an intersection location of at least two paths in a first terrain according to an embodiment of this application.

FIG. 6 is a schematic diagram of an obstacle and movement of a virtual object in a first terrain in a second virtual space according to an embodiment of this application.

FIG. 7 is a schematic diagram of teleportation prompt information according to an embodiment of this application.

FIG. 8 is a flowchart of a technology for interaction in a virtual scene according to an embodiment of this application.

FIG. 9 is a flowchart of a technology for a tile connection manner determining process according to an embodiment of this application.

FIG. 10 is a schematic diagram of a data table read in a maze generation process according to an embodiment of this application.

FIG. 11 is a schematic diagram of a data table read in a maze generation process according to an embodiment of this application.

FIG. 12 is a schematic diagram of a plurality of tiles according to an embodiment of this application.

FIG. 13 is a schematic diagram of logic for teleporting a virtual object to an entrance of a maze according to an embodiment of this application.

### DESCRIPTION OF EMBODIMENTS

To make the objectives, technical solutions, and advantages of this application clearer, the following describes embodiments of this application in further detail with reference to the accompanying drawings. The described embodiments are not to be considered as a limitation on the embodiments of this application. All other embodiments obtained by a person of ordinary skill in the art without creative efforts shall fall within the protection scope of this application.

In the following descriptions, related “some embodiments” describe a subset of all possible embodiments. However, the “some embodiments” may be the same subset or different subsets of all the possible embodiments, and may be combined with each other without conflict.

The term “first/second/third” involved in the following descriptions is merely used to distinguish between similar objects and does not indicate a specific order of objects. A specific order or sequence indicated by the term “first/second/third” can be changed where permitted, so that the embodiments of the disclosure described herein can be implemented in an order other than that illustrated or described herein.

Unless otherwise defined, meanings of all technical and scientific terms used in this specification are the same as those usually understood by a person skilled in the art to which this application belongs. Terms used herein are merely intended to describe the embodiments of this application, but are not intended to limit this application.

Before the embodiments of this application are further described in detail, descriptions are made on nouns and terms in the embodiments of this application, and the nouns and terms in the embodiments of this application are applicable to the following explanations.
(1) A shooting game is a game in which hot weapons are used for long-range attack, including, but not limited to, a first-person shooting game and a third-person shooting game.
(2) A third-person perspective is a perspective in which an in-game camera is located at a specific distance behind a player character and the character and all fight elements in a specific surrounding environment can be seen in a frame.
(3) “In response to” represents a condition or state upon which performed operations depend, where one or more of the performed operations may be real-time or may have a set delay when the condition or state upon which the operations depend is satisfied. Without being specifically stated, there is no limitation on an execution sequence of the plurality of performed operations.
(4) A virtual scene is a virtual scene displayed (or provided) when an application runs on a terminal. The virtual scene may be a simulated environment of a real world, may be a semi-simulated semi-fictional virtual environment, or may be an entirely fictional virtual environment. The virtual scene may be any one of a two-dimensional virtual scene, a 2.5-dimensional virtual scene, or a three-dimensional virtual scene.

For example, the virtual scene may include sky, land, ocean, and the like. The land may include environmental elements such as desert and city, and a user may control a virtual object to perform an activity in the virtual scene. The activity includes but is not limited to at least one of adjusting a body posture, crawling, walking, running, riding, jumping, driving, picking, shooting, attacking, and throwing. The virtual scene may be a virtual scene displayed from a first-person perspective (for example, the user plays as a virtual object in a game in an own perspective of the user), may be a virtual scene displayed from a third-person perspective (for example, the user plays a game chasing a virtual object in the game), or may be a virtual scene displayed from a large aerial perspective. The perspectives may be switched randomly.
(5) A virtual object is a figure of any person or object that can interact in a virtual scene, or a movable object in a virtual scene. The movable object may be a virtual character, a virtual animal, an animation character, and the like, for example, a character, an animal, a plant, an oil drum, a wall, and a stone displayed in the virtual scene. The virtual object may be a virtual image for representing a user in the virtual scene. The virtual scene may include a plurality of virtual objects, and each virtual object has a shape and a size in the virtual scene, and occupies some space in the virtual scene.

For example, the virtual object may be a user character controlled through an operation on a client, may be artificial intelligence (AI) set in a virtual scene fight through training, or may be a non-player character (NPC) set in virtual scene interaction. A quantity of virtual objects participating in interaction in the virtual scene may be preset, or may be dynamically determined based on a quantity of clients participating in interaction.
(6) A client, also referred to as a user side, is a program that corresponds to a server and that provides a local service to a user. In addition to some applications that can run only locally, the client is generally installed on a common user device and needs to cooperate with the server to run. In other words, the client requires a corresponding server and service program in a network to provide a corresponding service. Therefore, a specific communication connection needs to be established on the client and a server side, to ensure normal operation of an application, for example, a game client.
(7) An open world is a virtual game scene in which a battle scene in a game is completely free and open. In the open world, a player may freely move forward and explore in any direction, and a very long distance is defined between boundaries in various directions.

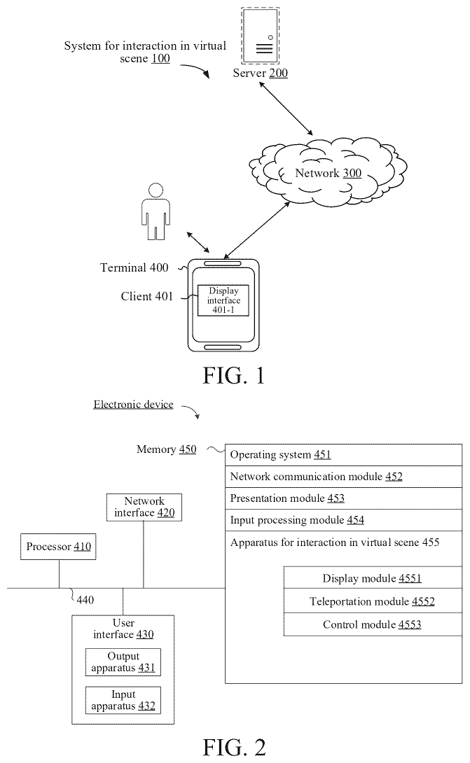

FIG. 1 is a schematic diagram of an architecture of a system 100 for interaction in a virtual scene according to an embodiment of this application, which is an application scenario of implementing interaction in a virtual scene (for example, the application scenario of interaction in the virtual scene may be an application scenario of performing interaction based on a virtual scene in a game application (APP), for example, when playing the game APP, a player teleports a virtual object to an entrance of a maze in the virtual scene, controls the virtual object to leave the maze when the virtual object moves from the entrance of the maze to an exit of the maze, and controls a path in the maze to change when the virtual object is teleported to the maze again, thereby teleporting the virtual object to an entrance of a changed maze). A terminal (a terminal 400 is shown as an example) is connected to a server 200 through a network 300. The network 300 may be a wide area network or a local area network, or a combination thereof. The terminal 400 is configured for a user to use and display a client 401 in a display interface (a display interface 401-1 is shown as an example). The terminal 400 and the server 200 are connected to each other through a wired or wireless network.

The server 200 is configured to send scene data of the virtual scene including the virtual object at a first location in a second virtual space to the terminal 400.

The terminal 400 is configured to: receive the scene data of the virtual scene including the virtual object at the first location in the second virtual space, and present the virtual scene based on the scene data; display, at the first location in the second virtual space in the virtual scene, the virtual object teleported from a first virtual space to the second virtual space in the virtual scene, the second virtual space having a first terrain, the first location being in the first terrain, and the first location being different from a location of an exit of the first terrain; teleport the virtual object back to the first virtual space when the virtual object moves from the first location to the exit of the first terrain; and control a terrain in the second virtual space to change from the first terrain to a second terrain when the virtual object is teleported from the first virtual space to the second virtual space again, and display the virtual object at a second location in the second terrain, the second location being different from a location of an exit of the second terrain.

In some embodiments, the server 200 may be an independent physical server, a server cluster or distributed system including a plurality of physical servers, or a cloud server providing a basic cloud computing service such as a cloud service, a cloud database, cloud computing, a cloud function, cloud storage, a network service, cloud communication, a middleware service, a domain name service, a security service, a content delivery network (CDN), or a big data and artificial intelligence platform. The terminal 400 may be a smartphone, a tablet computer, a notebook computer, a desktop computer, a set-top box, an intelligent voice interaction device, a smart home appliance, a virtual reality device, an on-board terminal, an aircraft, a mobile device (for example, a mobile phone, a portable music player, a personal digital assistant, a dedicated messaging device, a portable game device, a smart speaker, and a smartwatch), or the like, but is not limited thereto. The terminal may be connected directly or indirectly to the server in a wired or wireless communication manner. This is not limited in the embodiments of this application.

The following describes an electronic device that implements a method for interaction in a virtual scene according to an embodiment of this application. FIG. 2 is a schematic diagram of a structure of an electronic device according to an embodiment of this application. The electronic device may be a server or a terminal. An example in which the electronic device is the terminal shown in FIG. 1 is used. The electronic device shown in FIG. 2 includes at least one processor 410, a memory 450, at least one network interface 420, and a user interface 430. The components of the terminal 400 are coupled together via a bus system 440. The bus system 440 is configured to implement connection and communication between the components. In addition to a data bus, the bus system 440 further includes a power bus, a control bus, and a state signal bus. However, for clarity of description, various buses are marked as the bus system 440 in FIG. 2.

The processor 410 may be an integrated circuit chip with a signal processing capability, such as a general-purpose processor, a digital signal processor (DSP), or another programmable logic device, discrete gate, transistor logic device, or discrete hardware component. The general-purpose processor may be a microprocessor, any conventional processor, or the like.

The user interface 430 includes one or more output apparatuses 431 that enable medium content to be displayed, including one or more speakers and/or one or more visual display screens. The user interface 430 further includes one or more input apparatuses 432, including a user interface component that facilitates user input, such as a keyboard, a mouse, a microphone, a touchscreen, a camera, and other input buttons and controls.

The memory 450 may be removable, irremovable, or a combination thereof. For example, a hardware device includes a solid-state memory, a hard disk drive, an optical disk drive, and the like. In some embodiments, the memory 450 includes one or more storage devices physically located away from the processor 410.

The memory 450 includes a volatile memory or a non-volatile memory, or may include both a volatile memory and a non-volatile memory. The non-volatile memory may be a read-only memory (ROM), and the volatile memory may be a random access memory (RAM). The memory 450 described in this embodiment of this application is intended to include any suitable type of memory.

In some embodiments, the memory 450 can store data to support various operations. Examples of the data include a program, a module, a data structure, or a subset or a superset thereof, which are described below by way of example.

An operating system 451 includes system programs configured to process various basic system services and perform hardware-related tasks, for example, a framework layer, a core library layer, and a driver layer, and is configured to implement various basic services and process hardware-based tasks.

A network communication module 452 is configured to reach another electronic device through one or more (wired or wireless) network interfaces 420. For example, the network interface 420 includes a Bluetooth interface, a wireless fidelity (Wi-Fi) interface, a universal serial bus (USB) interface, and the like.

A presentation module 453 is configured to enable information to be displayed through the one or more output apparatuses 431 (for example, a display screen and a speaker) associated with the user interface 430 (for example, a user interface configured to operate a peripheral device and display content and information).

An input processing module 454 is configured to detect one or more user inputs or interactions from the input apparatuses 432 and translate the detected inputs or interactions.

In some embodiments, an apparatus provided in the embodiments of this application may be implemented by software. FIG. 2 shows an apparatus 455 for interaction in a virtual scene that is stored in the memory 450. The apparatus may be software in a form of a program or a plug-in, including the following software modules: a display module 4551, a teleportation module 4552, and a control module 4553. The modules are logical, and therefore may be arbitrarily combined or further split based on implemented functions. The functions of the modules are to be explained below.

In some other embodiments, the apparatus provided in the embodiments of this application may be implemented by hardware. As an example, the apparatus for interaction in a virtual scene provided in the embodiments of this application may be a processor in a form of a hardware decoding processor, programmed to perform the method for interaction in a virtual scene provided in the embodiments of this application. For example, the processor in the form of the hardware decoding processor may be one or more application-specific integrated circuits (ASICs), a DSP, a programmable logic device (PLD), a complex programmable logic device (CPLD), a field programmable gate array (FPGA), or another electronic component.

In some embodiments, the terminal or the server may implement the method for interaction in a virtual scene provided in the embodiments of this application by running a computer program. For example, the computer program may be an original program or a software module in an operating system, may be a native application (APP), to be specific, a program that needs to be installed in the operating system to run, such as an instant messaging APP, and a web browser APP, may be a mini program, to be specific, a program that can be run after being downloaded to a browser environment, or may be a mini program that can be embedded in any APP. In summary, the foregoing computer program may be an application, a module, or a plug-in in any form.

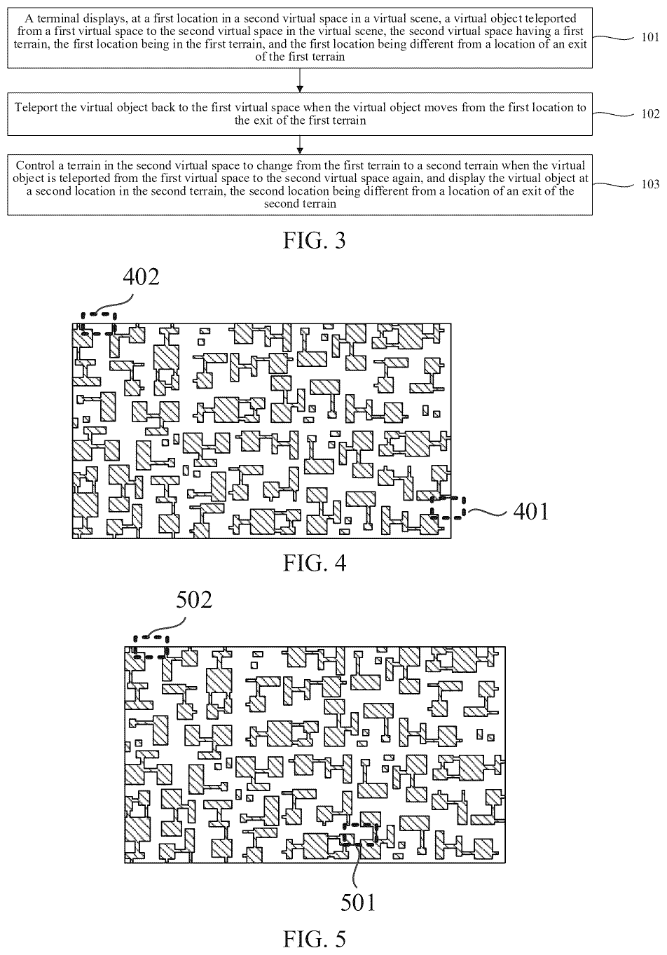

Based on the foregoing descriptions of the system for interaction in a virtual scene and the electronic device provided in the embodiments of this application, the following describes the method for interaction in a virtual scene provided in the embodiments of this application. In actual implementation, the method for interaction in a virtual scene provided in the embodiments of this application may be implemented by a terminal or a server alone, or may be implemented by the terminal and the server collaboratively. Descriptions are given by using an example in which the terminal 400 in FIG. 1 alone performs the method for interaction in a virtual scene provided in the embodiments of this application. FIG. 3 is a schematic flowchart of a method for interaction in a virtual scene according to an embodiment of this application, which is described with reference to operations shown in FIG. 3.

Operation 101: The terminal displays, at a first location in a second virtual space in a virtual scene, a virtual object teleported from a first virtual space to the second virtual space in the virtual scene, the second virtual space having a first terrain, the first location being in the first terrain, and the first location being different from a location of an exit of the first terrain.

In actual implementation, an application that supports the virtual scene is installed on the terminal. The application may be any one of a first-person shooting game, a third-person shooting game, a multiplayer online battle arena game, a virtual reality application, a three-dimensional map program, or a multiplayer gunfight survival game. A user may the terminal to operate a virtual object in the virtual scene to carry out an activity.

When the user opens the application on the terminal, and the terminal runs the application, the terminal presents a picture of the virtual scene. The picture of the virtual scene herein is obtained by observing the virtual scene from a first-person object perspective, or is obtained by observing the virtual scene from a third-person perspective. The picture of the virtual scene includes a virtual object. The virtual object may be a player character controlled by a current player, a player character controlled by another player (teammate) belonging to the same group as a current player, or the like.

The first virtual space and the second virtual space are preset, and belong to the same virtual scene. The first virtual space and the second virtual space may be set to virtual spaces such as a desert, an ocean, a castle, or a jungle. The first terrain in the second virtual space may be considered as a maze. The maze may include a plurality of paths. The plurality of paths are associated with at least one exit. The plurality of paths include at least one obstacle. The obstacle is configured to hinder the virtual object from moving in the first terrain. In addition, the first location is different from the location of the exit, and may be any non-exit location in the first terrain, that is, the maze, such as an entrance.

In some embodiments, before the virtual object teleported from the first virtual space to the second virtual space in the virtual scene is displayed at the first location in the second virtual space in the virtual scene, the virtual object and a virtual scene element that belongs to a natural phenomenon are displayed in the first virtual space in the virtual scene. When the virtual object is located in a sensing region of the virtual scene element, the virtual object is teleported from the first virtual space to the second virtual space. Herein, a virtual natural phenomenon to which a virtual scene element belongs may be a natural phenomenon caused to an environment such as a tornado or a volcano.

In actual application, the virtual scene element that belongs to the natural phenomenon is displayed, and a teleportation condition of the virtual object is defined. In other words, the virtual object is teleported only when the virtual object is located in the sensing region of the virtual scene element. This improves diversity of an interaction process, and improves immersion and interaction experience of the user. Therefore, efficiency of human-computer interaction and utilization of hardware resources of an electronic device are improved.

In actual implementation, when the virtual object is located in the sensing region of the virtual scene element, the sensing region herein is a circular region using the virtual scene element as a center and a target distance as a radius, and the target distance herein is preset, for example, 5 meters. In actual implementation, a process of determining that the virtual object is located in the sensing region of the virtual scene element specifically includes: The terminal obtains a location of the virtual object in the first virtual space, a location of the virtual scene element, and the sensing region of the virtual scene element, obtains a distance between the virtual object and the virtual scene element based on the location of the virtual object and the location of the virtual scene element, compares the distance with the radius of the sensing region, that is, the target distance, and determines that the virtual object is in a sensing range of the virtual scene element when a comparison result indicates that the distance is less than or equal to the radius of the sensing region, or determines that the virtual object is not in a sensing range of the virtual scene element when a comparison result indicates that the distance is greater than the target distance indicated by the sensing range of the virtual scene element.

When the virtual object is located in the sensing region of the virtual scene element, the virtual object may be directly teleported from the first virtual space to the second virtual space. Alternatively, the virtual object may be teleported from the first virtual space to the second virtual space based on duration for which the virtual object is in the sensing region. Specifically, a process of teleporting the virtual object from the first virtual space to the second virtual space when the virtual object is located in the sensing region of the virtual scene element may be: displaying dwell time of the virtual object in the sensing region when the virtual object is located in the sensing region of the virtual scene element; and teleporting the virtual object from the first virtual space to the second virtual space when the dwell time reaches a dwell time threshold. For example, when the virtual object is located in the sensing region of the virtual scene element, the dwell time of the virtual object in the first virtual space is detected; and the virtual object is teleported from the first virtual space to the second virtual space when a detection result indicates that the dwell time of the virtual object in the first virtual space reaches the dwell time threshold, for example, 5 seconds. The dwell time threshold may be preset. This is not limited in this embodiment of this application.

With application of the foregoing embodiment, the teleportation condition of the virtual object is further defined. For example, the virtual object is teleported from the first virtual space to the second virtual space only when the dwell time of the virtual object in the sensing region reaches the dwell time threshold. In this way, the diversity of the interaction process in the virtual scene and the enthusiasm of the user about exploration in the virtual scene are improved. Therefore, the efficiency of human-computer interaction and the utilization of the hardware resources of the electronic device are improved.

In some embodiments, as described above, the first location is different from the location of the exit, and may be any non-exit location, such as the entrance, in the first terrain, that is, the maze. When the first location is the entrance of the first terrain, a process of displaying, at the first location in the second virtual space in the virtual scene, the virtual object teleported from the first virtual space to the second virtual space in the virtual scene may be presenting, at the entrance in the second virtual space in the virtual scene, a process in which the virtual object appears in the second virtual space. For example, FIG. 4 is a schematic diagram of the second virtual space when the first location is the entrance of the first terrain according to an embodiment of this application. According to FIG. 4, a dashed box 401 indicates the entrance of the first terrain, and a dashed box 402 indicates the exit of the first terrain. Therefore, when the first location is the entrance of the first terrain, the process in which the virtual object appears in the second virtual space is presented at the entrance, shown as 401, of the second virtual space in the virtual scene.

In some other embodiments, as described above, a plurality of paths may be included. The plurality of paths are associated with at least one exit. In other words, the exit of the first terrain is associated with the plurality of paths. Therefore, when the first location is an intersection location of at least two paths, a process of displaying, at the first location in the second virtual space in the virtual scene, the virtual object teleported from the first virtual space to the second virtual space in the virtual scene may be presenting, at the intersection location of the at least two paths in the second virtual space in the virtual scene, that the virtual object appears in the second virtual space. For example, FIG. 5 is a schematic diagram of the second virtual space when the first location is the intersection location of the at least two paths in the first terrain according to an embodiment of this application. According to FIG. 5, a dashed box 501 indicates the intersection location of the at least two paths in the first terrain, and a dashed box 502 indicates the exit of the first terrain. Therefore, when the first location is the intersection location of the at least two paths in the first terrain, the process in which the virtual object appears in the second virtual space is presented at the intersection location of the at least two paths, shown as 501, in the second virtual space in the virtual scene.

Operation 102: Teleport the virtual object back to the first virtual space when the virtual object moves from the first location to the exit of the first terrain.

In actual implementation, as described above, the first location is different from the location of the exit, and may be any non-exit location, such as the entrance, in the first terrain, that is, the maze. Therefore, when the first location is the entrance of the first terrain, a process of teleporting the virtual object back to the first virtual space when the virtual object moves from the first location to the exit of the first terrain may be teleporting the virtual object back to the first virtual space when the virtual object moves from the entrance to the exit of the first terrain. Herein, there are a plurality of paths from the entrance to the exit. A path based on which the virtual object moves from the entrance to the exit of the first terrain is not limited in this embodiment of this application.

In actual application, the first location is defined, that is, the first location is defined as the entrance of the first terrain, so that the virtual object is teleported back to the first virtual space when the virtual object moves from the entrance to the exit of the first terrain. In this way, game experience of the user is improved while the diversity of the interaction process in the virtual scene is improved.

When the first location is the intersection location of the at least two paths, the virtual object may be further controlled, in response to a selection operation on a target path among the at least two paths, to enter the target path and move along the target path. Therefore, the process of teleporting the virtual object back to the first virtual space when the virtual object moves from the first location to the exit of the first terrain may be teleporting the virtual object back to the first virtual space when the virtual object moves to the exit of the first terrain in a movement process of the virtual object along the target path. Herein, because the virtual object is located at the intersection location of the at least two paths, there are at least two paths for the virtual object to select. Therefore, the virtual object is controlled to enter the target path and move along the target path in response to the selection operation on the target path among the at least two paths. In addition, the movement process herein may be moving forward or moving backward relative to a current location of the virtual object. This is not limited in this embodiment of this application.

With application of the foregoing embodiment, it is limited that when the first location is the intersection location of the at least two paths, the virtual object may select a path and move along the target path, so that the virtual object is teleported back to the first virtual space when the virtual object moves to the exit of the first terrain in the movement process of the virtual object along the target path. In this way, there are more interaction modes for the virtual object in the virtual scene. Therefore, the efficiency of human-computer interaction and the utilization of the hardware resources of the electronic device are improved.

In some embodiments, the virtual object may be further controlled to move in the first terrain in the second virtual space in response to a movement instruction for the virtual object; and an obstacle is displayed in the movement process of the virtual object, the obstacle being configured to hinder the virtual object from moving in the first terrain.

A direction movement control corresponding to the virtual object is further displayed while the virtual object teleported from the first virtual space to the second virtual space in the virtual scene is displayed at the first location in the second virtual space in the virtual scene. The direction movement control may be a joystick control. Then, in response to a movement control instruction received based on the direction movement control, the virtual object is controlled to move in the first terrain in the second virtual space based on a direction (including forward, backward, left, and right) indicated by the movement control instruction. The obstacle displayed in the movement process of the virtual object includes at least one of a dynamic obstacle and a static obstacle. The dynamic obstacle may be a monster, an animal, a moving prop, or the like. The static obstacle may be a laser, a plant, a fixed prop, or the like.

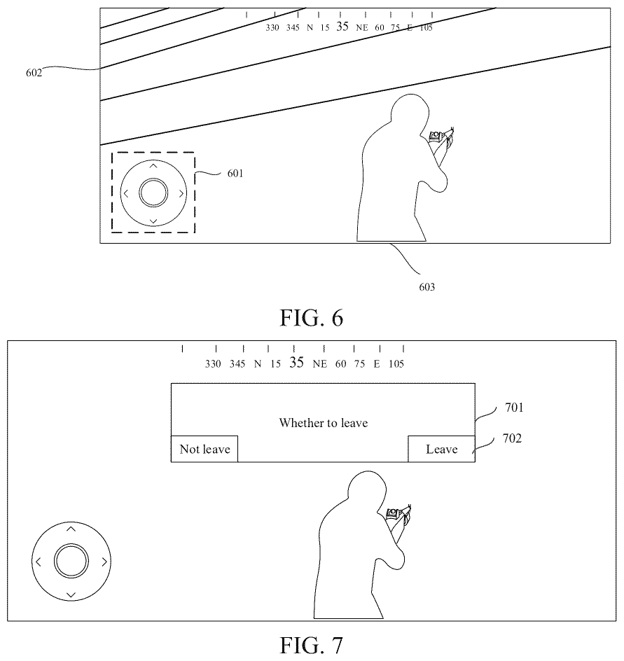

For example, FIG. 6 is a schematic diagram of the obstacle and movement of the virtual object in the first terrain in the second virtual space according to an embodiment of this application. According to FIG. 6, a dashed box 601 indicates a direction movement control. In response to a movement control instruction received by the direction movement control indicated by the dashed box 601, a virtual object shown as 603 is controlled to move in the first terrain in the second virtual space based on a direction (including forward, backward, left, and right) indicated by the movement control instruction. In addition, an obstacle shown as 602, that is, a laser, is displayed in the first terrain, to hinder, based on the obstacle indicated by 602, the virtual object from moving in the first terrain.

In actual application, the obstacle configured to hinder the virtual object from moving in the first terrain is displayed in the movement process of the virtual object. In this way, there are more interaction modes of the user in the virtual scene. Therefore, the diversity of the interaction process in the virtual scene is improved.

In some embodiments, after the obstacle is displayed, a target attribute value of the virtual object may be further controlled to decrease when the virtual object moves into a sensing range of the obstacle. The target attribute value includes at least one of the following: a hit point and a speed value of the virtual object.

The sensing range herein is determined based on a type of the obstacle. For example, when the obstacle is a laser, the sensing range herein is a cylindrical region formed by using the corresponding laser as an axis and a target distance as a radius. A process of determining that the virtual object is in the sensing range of the obstacle specifically includes: The terminal obtains a location of the virtual object in the second virtual space, a location of the obstacle, and the sensing range of the obstacle, obtains a distance between the virtual object and the obstacle based on the location of the virtual object and the location of the obstacle, compares the distance with the radius of the sensing range, that is, the target distance, and determines that the virtual object is in the sensing range of the obstacle when a comparison result indicates that the distance is less than or equal to the radius of the sensing region.

When the obstacle is the moving prop, the sensing range herein is a dynamic circular region formed by using the corresponding moving prop as a center and a target distance as a radius. A process of determining that the virtual object is in the sensing range of the obstacle specifically includes: The terminal obtains a location of the virtual object in the second virtual space, a location of the obstacle, and the sensing range of the obstacle, obtains a distance between the virtual object and the obstacle based on the location of the virtual object and the location of the obstacle, compares the distance with the radius of the sensing range, that is, the target distance, and determines that the virtual object is in the sensing range of the obstacle when a comparison result indicates that the distance is less than or equal to the radius of the sensing region.

In actual implementation, the target attribute value of the virtual object is controlled to decrease when the virtual object moves into the sensing range of the obstacle. The target attribute value includes at least one of the following: the hit point and the speed value of the virtual object. Herein, the target attribute value is configured for indicating an attribute value in strong correlation with the interaction process. For example, when the interaction process is that the virtual object moves to the exit of the first terrain within target duration, the target attribute value herein may be a speed of the virtual object. When the interaction process is that the virtual object moves to the exit of the first terrain within a target hit point, the target attribute value herein may be the hit point of the virtual object. For example, when the interaction process is that the virtual object moves to the exit of the first terrain within the target hit point, and the obstacle is the laser, the hit point of the virtual object is controlled to decrease when the virtual object moves into the sensing range of the laser, for example, touches the laser.

With application of the foregoing embodiment, the target attribute value of the virtual object is affected by using the obstacle, so that the virtual object can sense in real time and determine the impact caused by the obstacle to the virtual object, and perform an appropriate solution for eliminating the impact in time. Therefore, the efficiency of human-computer interaction and the utilization of the hardware resources of the electronic device are improved.

In some embodiments, the virtual object may be further controlled to avoid the obstacle. Specifically, the virtual object is controlled to perform a target motion in response to a motion instruction for the virtual object, the target motion being configured for the first virtual object to avoid the obstacle.

The controlling the virtual object to perform a target motion herein may be controlling the virtual object to perform an action such as jumping or moving, to avoid the obstacle through the action such as jumping or moving. In addition, when the target attribute value of the virtual object decreases, an action attribute of the virtual object for performing the target motion such as jumping or moving decreases, for example, a jumping capability decreases, or a moving speed decreases.

In actual application, the virtual object is controlled to avoid the obstacle, so that the virtual object can eliminate impact caused by the obstacle to the target attribute value of the virtual object in time. Therefore, the efficiency of human-computer interaction and the utilization of the hardware resources of the electronic device are improved.

In some embodiments, the virtual object is controlled to move in the first terrain in the second virtual space in response to a movement operation for the virtual object; and a process in which the virtual object reappears at the first location when a target condition for resetting a location of the virtual object is satisfied in the movement process of the virtual object. The target condition includes at least one of the following: movement duration of the virtual object in the first terrain reaches target duration, and the hit point of the virtual object decreases to a hit point threshold.

As described above, when the virtual object moves into the sensing range of the obstacle, the target attribute value of the virtual object decreases. Therefore, there is a correspondence between the target condition for resetting the location of the virtual object and a target attribute of the virtual object. For example, when the target attribute value is the hit point of the virtual object, the target condition for resetting the location of the virtual object herein may be that the hit point of the virtual object decreases to the hit point threshold. When the target attribute value is the speed value of the virtual object, the target condition for resetting the location of the virtual object herein may be that the movement duration of the virtual object in the first terrain reaches the target duration.

For example, when the target attribute value is the hit point of the virtual object, and the obstacle is the laser, the hit point of the virtual object decreases each time the virtual object touches the laser. Therefore, when the hit point of the virtual object decreases to the hit point threshold, and no exit is found, it is determined that the target condition for resetting the location of the virtual object is satisfied, and the virtual object is reset to the first location. When the target attribute value is the speed value of the virtual object, and the obstacle is the laser, the speed value of the virtual object decreases each time the virtual object touches the laser. Therefore, when the movement duration of the virtual object in the first terrain reaches the target duration, and no exit is found, it is determined that the target condition for resetting the location of the virtual object is satisfied, and the virtual object is reset to the first location.

In actual implementation, each time the virtual object touches the obstacle, the target attribute value of the virtual object is detected. When a detection result indicates that the target condition for resetting the location of the virtual object based on the target attribute value of the virtual object is satisfied, for example, the movement duration of the virtual object in the first terrain reaches the target duration, or the hit point of the virtual object decreases to the hit point threshold, a process in which the virtual object reappears at the first location is presented.

With application of the foregoing embodiment, when the target condition for resetting the location of the virtual object is satisfied, the virtual object is reset to the first location. In addition, it is also limited that the target condition is related to the movement duration and the hit point of the virtual object. In this way, it is ensured that the virtual object can perform a plurality of interaction processes in the virtual scene, the diversity of the interaction process in the virtual scene is improved, and interaction experience of the user is improved. Therefore, the efficiency of human-computer interaction and the utilization of the hardware resources of the electronic device are improved.

In some embodiments, when the target condition for resetting the location of the virtual object is satisfied, an initial target attribute value of the virtual object and a correlation coefficient of the initial target attribute value are obtained. A value of the correlation coefficient is negatively correlated with a quantity of resetting times of the virtual object. The initial target attribute value includes at least one of the following: an initial hit point and an initial speed value of the virtual object. The correlation coefficient and the initial target attribute value are multiplied to obtain an initial target attribute value when the virtual object reappears at the first location.

A larger quantity of resetting times of the virtual object indicates a smaller initial target attribute value when the virtual object reappears at the first location. Herein, the initial target attribute value is configured for indicating a target attribute value when the virtual object is teleported to the second virtual space. Specifically, when the target condition for resetting the location of the virtual object is satisfied, the initial target attribute value of the virtual object and the quantity of resetting times of the virtual object are obtained, the correlation coefficient of the initial target attribute value is obtained based on the quantity of resetting times, and then the initial target attribute value and the correlation coefficient are multiplied to obtain the initial target attribute value when the virtual object reappears at the first location, so that the virtual object moves in the first terrain based on the initial target attribute value when the virtual object reappears at the first location.

For example, when the target attribute value is the hit point, and the quantity of resetting times of the virtual object is 2, the correlation coefficient is 0.75. When the target condition for resetting the location of the virtual object is satisfied, the initial hit point, for example, 100, of the virtual object and the quantity 2 of resetting times of the virtual object are obtained twice, the correlation coefficient, that is, 0.75, of the initial target attribute value is obtained based on the quantity of resetting times, and then 100 and 0.75 are multiplied to obtain the initial target attribute value 75 when the virtual object reappears at the first location. In other words, when the virtual object is reset to the first location for the second time, the hit point of the virtual object is restored to 75 instead of 100.

There may be a preset correspondence between the quantity of resetting times and the correlation coefficient. For example, when the quantity of resetting times is 1, the correlation coefficient is 0.9; when the quantity of resetting times is 2, the correlation coefficient is 0.75; or when the quantity of resetting times is 3, the correlation coefficient is 0.6. This is not limited in this embodiment of this application.

In actual application, a larger quantity of resetting times of the virtual object indicates a smaller initial target attribute value when the virtual object reappears at the first location. In this way, the user does not abuse a resetting opportunity, and can use the resetting opportunity more carefully, thereby ensuring balance in the interaction process in the virtual scene, and improving the diversity of the interaction process in the virtual scene and interaction enthusiasm of the user. Therefore, the efficiency of human-computer interaction and the utilization of the hardware resources of the electronic device are improved.

In actual implementation, when the virtual object moves from the first location to the exit of the first terrain, there are a plurality of manners for teleporting the virtual object back to the first virtual space. The following uses two of the manners as examples to describe the process of teleporting the virtual object back to the first virtual space when the virtual object moves from the first location to the exit of the first terrain.

In some embodiments, when the virtual object moves from the first location to the exit of the first terrain, a first virtual resource used as a reward may be further displayed, the first virtual resource being configured for use in the first virtual space. The first virtual resource is claimed in response to a claiming operation on the first virtual resource, and the virtual object is teleported back to the first virtual space. Herein, the first virtual resource may be an interactive prop used for the virtual object in the first virtual space, an experience point for improving a level of the virtual object, or the like.

With application of the foregoing embodiment, when the virtual object moves from the first location to the exit of the first terrain, a virtual resource used as a reward is displayed in the virtual scene. In this way, the diversity of the interaction process in the virtual scene is improved, and the enthusiasm of the user about movement in the virtual scene is enhanced.

In some other embodiments, when the virtual object moves from the first location to the exit of the first terrain, teleportation prompt information is displayed, the teleportation prompt information being configured for prompting whether to teleport the virtual object back to the first virtual space. The virtual object is teleported back to the first virtual space in response to a teleportation instruction triggered based on the teleportation prompt information. For example, FIG. 7 is a schematic diagram of the teleportation prompt information according to an embodiment of this application. According to FIG. 7, when the virtual object moves from the first location to the exit of the first terrain, teleportation prompt information indicated by 701 is displayed, and then the virtual object is teleported back to the first virtual space in response to a teleportation instruction triggered based on a leave control shown as 702.

In actual application, the teleportation prompt information for the user to confirm whether to teleport the virtual object back to the first virtual space is further displayed, and the virtual object is teleported back to the first virtual space only when the user confirms to teleport the virtual object back to the first virtual space. In this way, the user may select whether to teleport the virtual object back to the first virtual space. This gives the user more choices, thereby improving the diversity of the interaction mode in the virtual scene, and improving the interaction experience of the user.

In some embodiments, a virtual resource may be further displayed in the movement process of the virtual object. Specifically, the virtual object is controlled to move in the first terrain in the second virtual space in response to the movement instruction for the virtual object; and when the virtual object moves to a target location in the first terrain, a second virtual resource used as a reward is displayed, the second virtual resource being configured for use in the second virtual space.

The second virtual resource may be an interactive prop used for the virtual object in the second virtual space, the experience point for improving the level of the virtual object, or the like. The target location is a specific location in the first terrain. This location may be preset or randomly set, or may be determined based on a current location of the virtual object. For example, the current location of the virtual object is detected in real time, and when a detection result indicates that a distance between the current location of the virtual object and the exit reaches a target distance threshold, the current location of the virtual object is determined as the target location, to display, at the target location, the second virtual resource used as the reward. Herein, there may be a plurality of target distance thresholds, for example, 300 meters, 200 meters, and 100 meters. In this way, a plurality of second virtual resources may be displayed in the movement process of the virtual object based on the plurality of target distance thresholds. Therefore, the enthusiasm of the virtual object about movement and the interaction experience are improved.

With application of the foregoing embodiment, when the virtual object moves to the target location in the first terrain, the virtual resource used as the reward is displayed in the virtual scene. In this way, the diversity of the interaction process in the virtual scene is improved, and the enthusiasm of the user about movement in the virtual scene is enhanced.

In some embodiments, at least one obstacle is disposed in the first terrain, and the obstacle is configured to hinder the virtual object from moving in the first terrain. Therefore, the obstacle may be further removed. Specifically, task guidance information for an interaction task is displayed; the virtual object is controlled, based on the task guidance information in response to a task execution instruction for the interaction task, to perform the interaction task; and when the virtual object completes the interaction task, the obstacle included in the first terrain is removed. Herein, before the task guidance information for the interaction task is displayed, the interaction task for the obstacle is recognized. Then, the task guidance information for the interaction task is displayed, to present a process in which the virtual object performs the interaction task based on the task guidance information. When the virtual object completes the interaction task, the obstacle included in the first terrain is removed. The interaction task herein may be preset. The interaction task may be a catapulting task, a line drawing task, a composite task, or the like.

The task guidance information includes at least one of description information of the interaction task and condition information for completing the interaction task. The description information is configured for describing an execution process of the interaction task, that is, operations. The condition information is configured for indicating a condition required for completing the interaction task. For example, when the interaction task is the line drawing task, the description information of the interaction task may be descriptions about operations of the line drawing task, for example, connecting two same elements. The condition information of the interaction task is the condition required for completing the interaction task, for example, connecting a target quantity of elements.

In actual application, the obstacle is removed when the virtual object completes the interaction task, so that the user may remove the obstacle, and the virtual object can eliminate impact caused by the obstacle to the virtual object in time. This not only improves the diversity of the interaction process in the virtual scene, but also improves the efficiency of human-computer interaction and the utilization of the hardware resources of the electronic device.

In actual implementation, at least two types of obstacles are disposed in the first terrain, the at least two types of obstacles are configured to hinder the virtual object from moving in the first terrain, and different types of obstacles are associated with different interaction tasks. Therefore, a target type of obstacle may be further removed. Specifically, task guidance information for an interaction task associated with each type of obstacle is displayed; the virtual object is controlled, based on the task guidance information in response to a task execution instruction for a target interaction task, to perform the target interaction task; and when the virtual object completes the target interaction task, a target type of obstacle associated with the target interaction task in the first terrain is removed.

In actual implementation, there are a plurality of types of obstacles, and different types of obstacles are associated with different interaction tasks. Therefore, a process of controlling, based on the task guidance information in response to the task execution instruction for the target interaction task, the virtual object to perform the target interaction task may be: recognizing the interaction task for each type of obstacle; displaying a task option and the task guidance information for each type of obstacle; and selecting, based on the task guidance information in response to a selection operation on a target task option in a plurality of task options, the target interaction task corresponding to the target task option as the interaction task performed by the virtual object, and presenting a process in which the virtual object performs the target interaction task based on the task guidance information. Therefore, when the virtual object completes the target interaction task, the target type of obstacle associated with the target interaction task in the first terrain is removed.

The interaction task may be a catapulting task, a line drawing task, a composite task, or the like. Different types of obstacle are associated with different interaction tasks. For example, an interaction task associated with and corresponding to a layer-type obstacle may be the catapulting task, and an interaction task associated with and corresponding to a monster-type obstacle may be the line drawing task. As described above, the task guidance information also includes at least one of description information of the interaction task and condition information for completing the interaction task. The description information is configured for describing an execution process of the interaction task, that is, operations. The condition information is configured for indicating a condition required for completing the interaction task.

With application of the foregoing embodiment, different types of obstacles are limited to be associated with different interaction tasks, so that the virtual object completes different interaction tasks to remove different types of obstacles. In this way, the user can select a type of obstacle to eliminate based on an interaction task, and may also perform different interaction tasks. Therefore, not only is the diversity of the interaction process in the virtual scene improved, but also user experience and the efficiency of human-computer interaction are improved.

Operation 103: Control a terrain in the second virtual space to change from the first terrain to a second terrain when the virtual object is teleported from the first virtual space to the second virtual space again, and display the virtual object at a second location in the second terrain, the second location being different from a location of an exit of the second terrain.

In some embodiments, before the virtual object teleported from the first virtual space to the second virtual space in the virtual scene is displayed at the first location in the second virtual space in the virtual scene, a first virtual object and a second virtual object may be further displayed in the first virtual space in the virtual scene. Therefore, when the first virtual object and the second virtual object are teleported to the second virtual space, the first virtual object is displayed at a third location different from the exit in the second virtual space in the virtual scene, and the second virtual object is displayed at a fourth location different from the exit in the second virtual space in the virtual scene. The third location and the fourth location are different locations. A distance between the third location and the exit is different from a distance between the fourth location and the exit.

The first virtual object may be a player character controlled by the current player, or may be a player character controlled by another player (teammate) belonging to the same group as the current player. The second virtual object may be a player character controlled by another player (teammate) belonging to the same group as the current player, may be a player character controlled by another player belonging to an enemy camp of a player character controlled by the current player, or may be an AI-controlled object for the player to interact in the virtual scene, an NPC in the virtual scene, or the like.

In actual implementation, when the first virtual object and the second virtual object are teleported to the second virtual space together, the third location and the fourth location are determined based on a game attribute of the corresponding first virtual object and a game attribute of the corresponding second virtual object, such as battle performance and a level. Specifically, when the first virtual object and the second virtual object are teleported to the second virtual space together, the game attribute of the first virtual object and the game attribute of the second virtual object are obtained, the game attribute of the first virtual object is parsed to obtain the third location corresponding to the first virtual object, and the game attribute of the second virtual object is parsed to obtain the fourth location corresponding to the second virtual object, so that the first virtual object is displayed at the third location different from the exit in the second virtual space in the virtual scene, and the second virtual object is displayed at the fourth location different from the exit in the second virtual space in the virtual scene.

Parameters related to the game attributes of the first virtual object and the second virtual object may be in negative correlation or positive correlation with distances between the exit and locations in the second virtual space to which the first virtual object and the second virtual object are teleported. Specifically, when the parameters related to the game attributes of the first virtual object and the second virtual object is in negative correlation with the distances between the exit and the locations in the second virtual space to which the first virtual object and the second virtual object are teleported, for example, when the game attributes are the levels or game win rates of the first virtual object and the second virtual object, higher levels or higher game win rates of the first virtual object and the second virtual object indicate shorter distances between exit and the locations in the second virtual space to which the first virtual object and the second virtual object are teleported, that is, when the level or the game win rate of the first virtual object is higher than that of the second virtual object, the distance between the third location and the exit is less than the distance between the fourth location and the exit. When the parameters related to the game attributes of the first virtual object and the second virtual object is in positive correlation with the distances between the exit and the locations in the second virtual space to which the first virtual object and the second virtual object are teleported, for example, when the game attributes are the levels or game win rates of the first virtual object and the second virtual object, higher levels or higher game win rates of the first virtual object and the second virtual object indicate longer distances between exit and the locations in the second virtual space to which the first virtual object and the second virtual object are teleported, that is, when the level or the game win rate of the first virtual object is higher than that of the second virtual object, the distance between the third location and the exit is greater than the distance between the fourth location and the exit.

A relationship between the parameters related to the game attributes of the first virtual object and the second virtual object and the distances between the exit and the location in the second virtual space to which the first virtual object and the second virtual object are teleported may be preset. This is not limited in this embodiment of this application.

In actual application, when two virtual objects are teleported to the second virtual space together, different virtual objects are teleported to different locations. In this way, the diversity of the interaction process in the virtual scene is improved, and the interaction experience of the user is improved. Therefore, the efficiency of human-computer interaction and the utilization of the hardware resources of the electronic device are improved.

In some embodiments, when the first virtual object and the second virtual object are teleported to the second virtual space together, different virtual objects may further correspond to different terrains. Specifically, the first virtual object is teleported to a fifth location different from a location of an exit in a third terrain, and the second virtual object is teleported to a sixth location different from a location of an exit in a fourth terrain. The second virtual space has the third terrain and the fourth terrain, and the third terrain is different from the fourth terrain. Herein, the fifth location and the sixth location may be the same or different. When the fifth location and the sixth location are different, a process of determining the fifth location and the sixth location is the same as the foregoing process of determining the third location and the fourth location. Details are not described in this embodiment of this application again.

When the first virtual object and the second virtual object are teleported to the second virtual space together, the third terrain and the fourth terrain are determined based on the game attribute of the corresponding first virtual object and the game attribute of the corresponding second virtual object, such as the battle performance and the level. Specifically, when the first virtual object and the second virtual object are teleported to the second virtual space together, the game attribute of the first virtual object and the game attribute of the second virtual object are obtained, the game attribute of the first virtual object is parsed to obtain the third terrain corresponding to the first virtual object, and the game attribute of the second virtual object is parsed to obtain the fourth terrain corresponding to the second virtual object, so that the first virtual object is teleported to the fifth location different from the location of the exit in the third terrain, and the second virtual object is teleported to the sixth location different from the location of the exit in the fourth terrain.

The parameters related to the game attributes of the first virtual object and the second virtual object may be in negative correlation or positive correlation with complexities of terrains in the second virtual space to which the first virtual object and the second virtual object are teleported. Specifically, when the parameters related to the game attributes of the first virtual object and the second virtual object is in negative correlation with the complexities of the terrains in the second virtual space to which the first virtual object and the second virtual object are teleported, for example, when the game attributes are the levels or game win rates of the first virtual object and the second virtual object, higher levels or higher game win rates of the first virtual object and the second virtual object indicate lower complexities of the terrains in the second virtual space to which the first virtual object and the second virtual object are teleported, that is, when the level or the game win rate of the first virtual object is higher than that of the second virtual object, a complexity of the third terrain is lower than that of the fourth terrain. When the parameters related to the game attributes of the first virtual object and the second virtual object is in positive correlation with the complexities of the terrains in the second virtual space to which the first virtual object and the second virtual object are teleported, for example, when the game attributes are the levels or game win rates of the first virtual object and the second virtual object, higher levels or higher game win rates of the first virtual object and the second virtual object indicate higher complexities of the terrains in the second virtual space to which the first virtual object and the second virtual object are teleported, that is, when the level or the game win rate of the first virtual object is higher than that of the second virtual object, the complexity of the third terrain is higher than that of the fourth terrain.

The terrain in the second virtual space is formed by combining a plurality of tiles. There is a corresponding connection manner for each tile, for indicating a direction in which the corresponding tile can be connected, for example, a direction among six directions of east, south, west, north, up, and down in which connection can be performed. For example, any tile having a connection direction may be connected to the east, south, west, and north of a tile at a crossroad. However, for a tile at a T-shaped intersection, there are only three directions in which a tile having a connection direction can be connected, and there is one direction to which only a tile having no connection direction can be connected. In other words, the connection manner corresponding to each tile may be preset. In addition to directly defining the direction in which the tile can be connected, the connection manner for the tile may be set by using an escape character. For example, an escape character A indicates that the tile never faces a boundary, and an escape character B indicates that the tile permanently faces the boundary. Herein, a process of setting the connection manner for the tile is not limited in this embodiment of this application.

In some embodiments, for a process of controlling the terrain in the second virtual space to change from the first terrain to the second terrain, the plurality of tiles in the second virtual space that are configured to generate the terrain are first obtained, and then the plurality of tiles are randomly combined to obtain a new terrain. In other words, the process of controlling the terrain in the second virtual space to change from the first terrain to the second terrain may be randomly combining the plurality of tiles to obtain the second terrain.

In some other embodiments, for a process of controlling the terrain in the second virtual space to change from the first terrain to the second terrain, a target terrain may be obtained from a preset terrain library including a plurality of terrains, to determine the target terrain as the second terrain.

The virtual object carries a quantity of times identifier for indicating a quantity of times of teleporting the virtual object to the second virtual space, and different quantity of times identifiers correspond to different terrains. Therefore, a process of obtaining the target terrain may be: obtaining the quantity of times identifier carried by the virtual object, and obtaining, based on the quantity of times identifier, the target terrain corresponding to the quantity of times identifier. Therefore, the target terrain is determined as the second terrain, to implement the process of controlling the terrain in the second virtual space to change from the first terrain to the second terrain. In this way, each time the virtual object enters the second virtual space, the terrain is different.

With application of the foregoing embodiment of this application, the virtual object is teleported from the first virtual space in the virtual scene to the first location different from the exit in the second virtual space. The second virtual space has the first terrain, and the first location is in the first terrain. The virtual object is teleported back to the first virtual space when the virtual object moves from the first location to the exit of the first terrain. When the virtual object is teleported from the first virtual space to the second virtual space again, the terrain in the second virtual space is controlled to change from the first terrain to the second terrain, and the virtual object is displayed at the second location different from the location of the exit in the second terrain. In this way, when the virtual object is teleported to the second virtual space for the first time, the virtual object is teleported to the first terrain that the second virtual space has, and after the virtual object leaves the second virtual space, when the virtual object is teleported to the second virtual space again, the terrain in the second virtual space is controlled to change from the first terrain to the second terrain, so that the virtual object is teleported to the second terrain that the second virtual space has. In this way, each time the virtual object is teleported to the second virtual space, the terrain that the second virtual space has is dynamically changed. Compared with teleporting the virtual object to a fixed terrain each time, this improves utilization of terrain resources in the virtual scene, thereby improving the efficiency of human-computer interaction and the utilization of the hardware resources of the electronic device.

The following describes exemplary application of this embodiment of this application in an actual application scenario.

In the related art, designing a terrain in a game scene costs a large quantity of planning and art resources. Therefore, to save resources, many games may be designed with fixed maps or terrains for a same game scene. However, interaction of players only in the fixed maps or terrains results in a single interaction process of the players. Consequently, efficiency of human-computer interaction is excessively low.

Based on this, the embodiments of this application provide a method and an apparatus for interaction in a virtual scene, an electronic device, a non-transitory computer-readable storage medium, and a computer program product. Each time a player enters a dynamic maze, a maze structure is completely different from that when the player enters the maze last time. The maze includes an entrance, an exit, and an obstacle. In this way, game experience of the player is improved by using the dynamically generated maze, and playability is also improved.

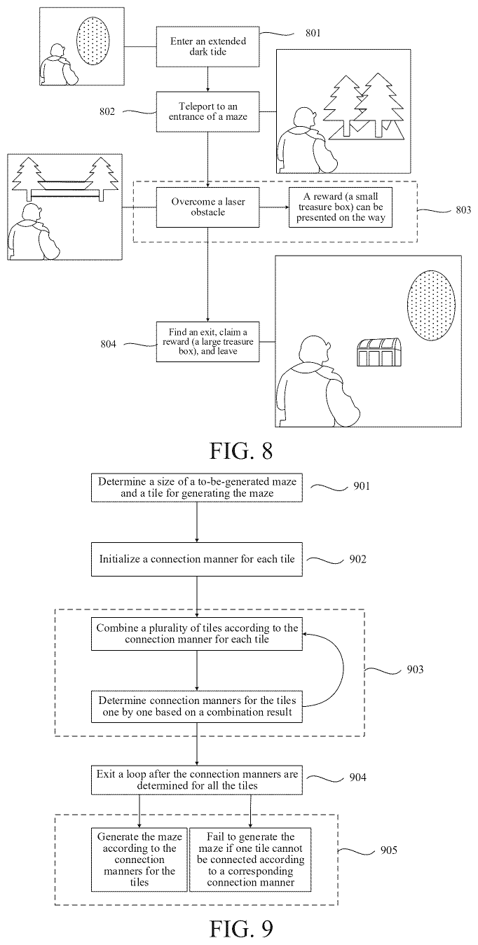

The following describes the technical solution of this application in detail from a product side. FIG. 8 is a flowchart of a technology for interaction in a virtual scene according to an embodiment of this application. According to FIG. 8, the technical solution provided in this application is implemented by using operation 801 to operation 804. Specifically, after a virtual object controlled by the player enters a special dark tide (a second virtual space), the virtual object is teleported to the entrance of the maze in the second virtual space, and when the virtual object moves in the maze, a laser obstacle (obstacle) is displayed in the maze. The laser may also damage the virtual object (a target attribute value of the virtual object is controlled to decrease). When the virtual object moves in the maze, a reward (a second virtual resource) is further displayed in the maze, the virtual object is controlled to avoid the laser obstacle, and the virtual object is controlled to claim the reward. Herein, there are a plurality of practicable routes from the entrance to the exit of the maze. When the virtual object moves to the exit of the maze, it is determined that the virtual object wins, and a reward (a first virtual resource) is displayed. The laser may damage the virtual object. When the virtual object is damaged by the laser to an extremely low blood volume, the virtual object is teleported to the entrance of the maze.

The following describes the technical solution of this application in detail from a technology side. The maze is formed by combining a plurality of tiles. There is a corresponding connection manner for each tile, for indicating a direction in which the corresponding tile can be connected, for example, a direction among six directions of east, south, west, north, top, and bottom in which connection can be performed. For example, any tile having a connection direction may be connected to the east, south, west, and north of a tile at a crossroad, for example, an X-shaped intersection. However, for a tile at a T-shaped intersection, there are only three directions in which a tile having a connection direction can be connected, and there is one direction to which only a tile having no connection direction can be connected. In other words, the connection manner corresponding to each tile may be preset. In addition to directly defining the direction in which the tile can be connected, the connection manner for the tile may be set by using an escape character. For example, an escape character A indicates that the tile never faces a boundary, and an escape character B indicates that the tile permanently faces the boundary. Herein, a process of setting the connection manner for the tile is not limited in this embodiment of this application.

FIG. 9 is a flowchart of a technology for a tile connection manner determining process according to an embodiment of this application. According to FIG. 9, the tile connection manner determining process is implemented by using operation 901 to operation 905. Specifically, a size of the maze and the plurality of tiles configured to generate a terrain are first obtained. Then, the connection manner for each tile is initialized. The plurality of tiles is combined according to the connection manner for each tile. Connection manners are determined for the tiles one by one based on a combination result. When connection manners for all the tiles are determined, a loop is exited. Therefore, the connection manners for all the tiles are determined. Then, the plurality of tiles are randomly combined according to the connection manners for all the tiles, to obtain the maze.

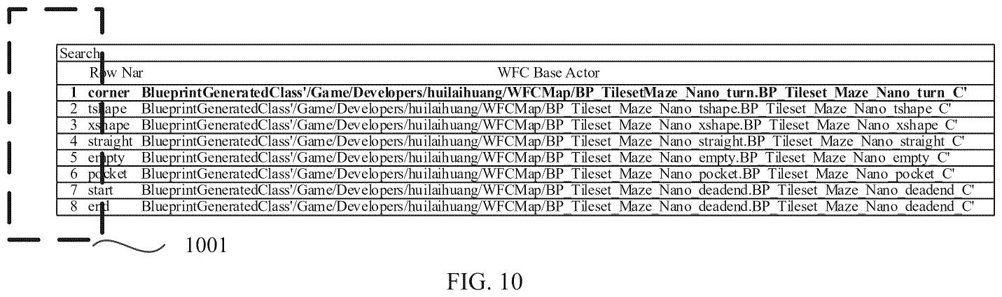

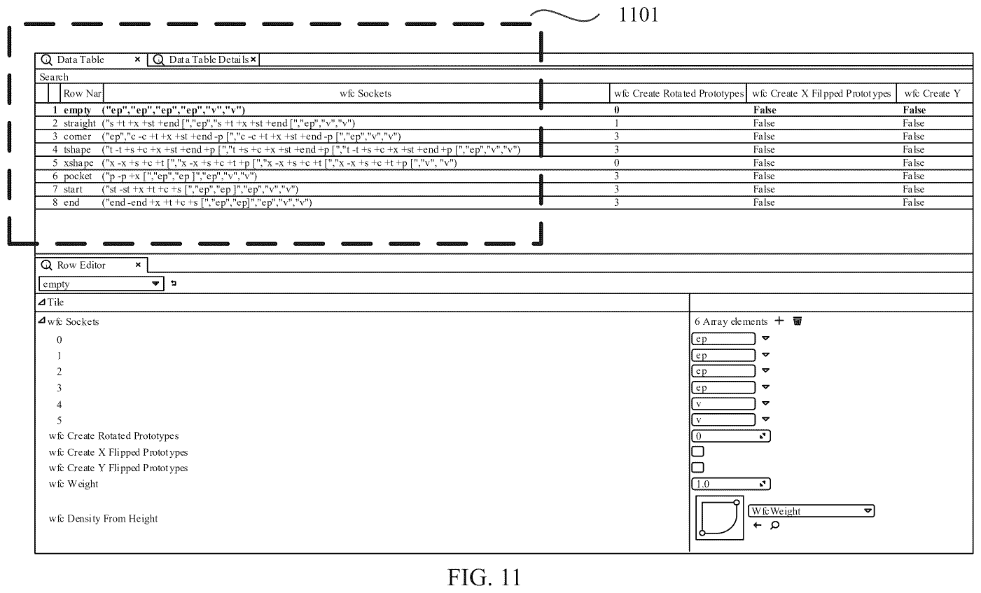

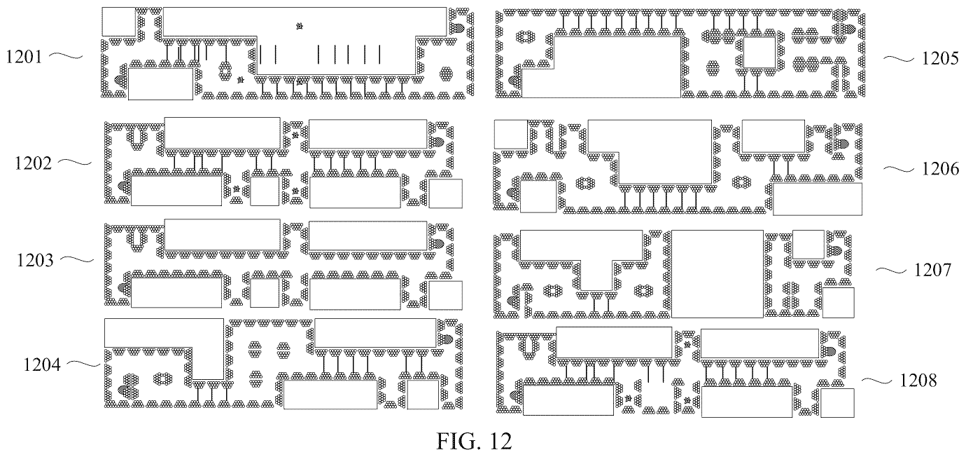

When the maze is generated, two data tables need to be read, where one is configured for storing the tiles, and the other is configured for defining the connection manner for each tile. For example, as shown in FIG. 10 and FIG. 11, FIG. 10 is a schematic diagram of a data table read in a maze generation process according to an embodiment of this application, and FIG. 11 is a schematic diagram of a data table read in a maze generation process according to an embodiment of this application. According to FIG. 10, a dashed box 1001 shows eight tiles in which there are a plurality of locations. A tile 2, a tile 3, a tile 7, and a tile 8 are used as examples. For the tile 2, that is, a T-shaped tile for forming a T-shaped intersection, there are only three directions in which a tile having a connection direction can be connected, and there is one direction in which only a tile having no connection direction can be connected. For the tile 3, that is, an X-shaped tile for forming a crossroad, there are four directions in which a tile having a connection direction can be connected. For the tile 7, that is, a start tile for indicating a location of the entrance of the maze, there is one direction in which a tile having a connection direction can be connected, and there are three directions in which only a tile having no connection direction can be connected. For the tile 8, that is, an end tile for indicating a location of the exit of the maze, there is one direction in which a tile having a connection direction can be connected, and there are three directions in which only a tile having no connection direction can be connected. In this way, when the maze is generated, the eight tiles shown in the dashed box 1001 in FIG. 10 are read. As shown in FIG. 10, there is a set of specific rules for each side of each tile, for connecting a side of another tile or the tile. In addition, an additional rule may be developed by using an escape character. According to FIG. 11, a dashed box 1101 shows a connection manner defined for each tile based on the escape character. For example, “[” indicates never facing a boundary, and “]” indicates permanently facing the boundary. Therefore, when the maze is generated, a connection manner for each tile indicated by the dashed box 1101 in FIG. 11 is read, and the plurality of tiles are connected and combined randomly according to the connection manner for each tile, to generate a map. For example, FIG. 12 is a schematic diagram of a plurality of tiles according to an embodiment of this application. According to FIG. 12, FIG. 12 includes eight tiles shown as 1201 to 1208, so that a maze map is randomly generated based on the eight tiles.

In some other embodiments, a target maze may be obtained from a preset maze library including a plurality of mazes (terrains), to determine the target terrain as a new maze. Herein, different players (virtual objects) carry quantity of times identifiers for indicating quantities of times of teleporting the virtual objects, and different quantity of times identifiers correspond to different mazes. Therefore, a process of obtaining the target maze may be: obtaining a quantity of times identifier carried by the virtual object controlled by the player, and obtaining, based on the quantity of times identifier, the target maze corresponding to the quantity of times identifier. Therefore, each time the player enters the dark tide, the maze is different. In this way, the dynamically generated maze improves diversity of a playing method for the player, and provides better game experience for the player. In addition, the dynamic maze is extremely extensible for a designer, so that a large quantity of different mazes can be generated in a short time, improving diversity of an interaction process.

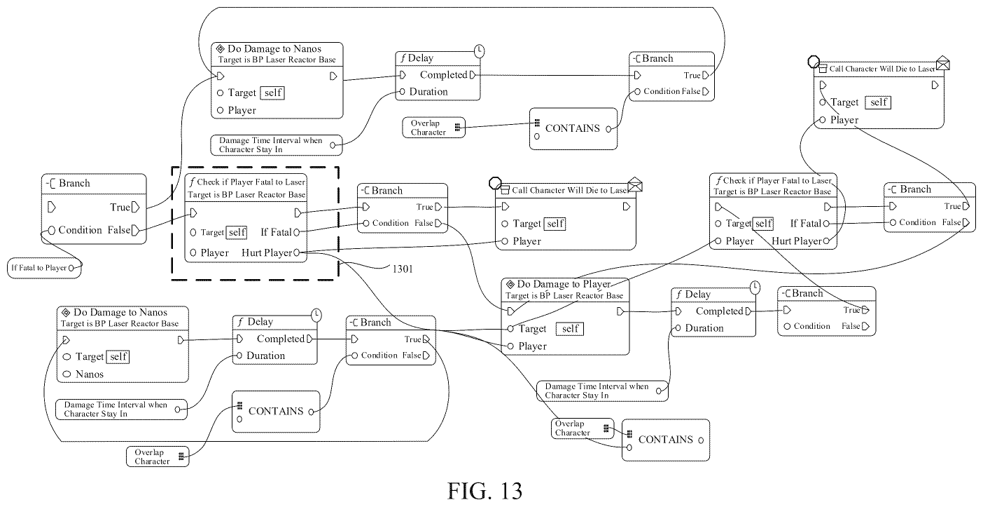

In actual implementation, because the laser may damage the virtual object, if the player plays for the first time, the player may easily die in the dynamic maze. This is poor experience for the player. In addition, it is difficult for a teammate to offer rescue, and costs of exploring the maze become high. Therefore, FIG. 13 is a schematic diagram of logic for teleporting the virtual object to the entrance of the maze according to an embodiment of this application. According to FIG. 13, as shown by a dashed box 1301 in FIG. 13, when the virtual object encounters the laser, a blood volume (a hit point) of the virtual object is detected once. If the blood volume of the virtual object is sufficient to take this damage, the virtual object continues to play the game; or if the blood volume of the virtual object is insufficient to take this damage, the virtual object is teleported to the entrance of the maze, for example, the virtual object is teleported to the entrance of the maze and restored to a blood volume of 75%, so that the virtual object moves in the maze again based on the blood volume of 75%.

With application of the foregoing embodiment of this application, the virtual object is teleported from the first virtual space in the virtual scene to the first location different from the exit in the second virtual space. The second virtual space has the first terrain, and the first location is in the first terrain. The virtual object is teleported back to the first virtual space when the virtual object moves from the first location to the exit of the first terrain. When the virtual object is teleported from the first virtual space to the second virtual space again, the terrain in the second virtual space is controlled to change from the first terrain to the second terrain, and the virtual object is displayed at the second location different from the location of the exit in the second terrain. In this way, when the virtual object is teleported to the second virtual space for the first time, the virtual object is teleported to the first terrain that the second virtual space has, and after the virtual object leaves the second virtual space, when the virtual object is teleported to the second virtual space again, the terrain in the second virtual space is controlled to change from the first terrain to the second terrain, so that the virtual object is teleported to the second terrain that the second virtual space has. In this way, each time the virtual object is teleported to the second virtual space, the terrain that the second virtual space has is dynamically changed. Compared with teleporting the virtual object to a fixed terrain each time, this improves utilization of terrain resources in the virtual scene, thereby improving the efficiency of human-computer interaction and the utilization of the hardware resources of the electronic device.

An exemplary structure of the apparatus 455 for interaction in a virtual scene provided in the embodiments of this application implemented as a software module continues to be described below. In some embodiments, as shown in FIG. 2, the software module in the apparatus 455 for interaction in a virtual scene stored in the memory 450 may include:
the display module 4551, configured to display, at a first location in a second virtual space in a virtual scene, a virtual object teleported from a first virtual space to the second virtual space in the virtual scene, the second virtual space having a first terrain, the first location being in the first terrain, and the first location being different from a location of an exit of the first terrain;
the teleportation module 4552, configured to teleport the virtual object back to the first virtual space when the virtual object moves from the first location to the exit of the first terrain; and
the control module 4553, configured to control a terrain in the second virtual space to change from the first terrain to a second terrain when the virtual object is teleported from the first virtual space to the second virtual space again, and display the virtual object at a second location in the second terrain, the second location being different from a location of an exit of the second terrain.

In some embodiments, the first location is an entrance of the first terrain. The display module 4551 is further configured to present, at the entrance in the second virtual space in the virtual scene, a process in which the virtual object appears in the second virtual space. The teleportation module 4552 is further configured to teleport the virtual object back to the first virtual space when the virtual object moves from the entrance to the exit of the first terrain.

In some embodiments, the exit of the first terrain is associated with a plurality of paths. The apparatus further includes a second control module. The second control module is configured to control, in response to a selection operation on a target path among at least two paths when the first location is an intersection location of the at least two paths, the virtual object to enter the target path and move along the target path. The teleportation module 4552 is further configured to teleport the virtual object back to the first virtual space when the virtual object moves to the exit of the first terrain in a movement process of the virtual object along the target path.

In some embodiments, the apparatus further includes a third control module. The third control module is configured to: control the virtual object to move in the first terrain in the second virtual space in response to the movement instruction for the virtual object; and display an obstacle in the movement process of the virtual object, the obstacle being configured to hinder the virtual object from moving in the first terrain.

In some embodiments, the apparatus further includes a fourth control module. The fourth control module is configured to control a target attribute value of the virtual object to decrease when the virtual object moves into a sensing range of the obstacle, the target attribute value including at least one of the following: a hit point and a speed value of the virtual object.

In some embodiments, the apparatus further includes a fifth control module. The fifth control module is configured to control the virtual object to perform a target motion in response to a motion instruction for the virtual object, the target motion being configured for the virtual object to avoid the obstacle.

In some embodiments, the apparatus further includes a resetting module. The resetting module is configured to: control the virtual object to move in the first terrain in the second virtual space in response to a movement operation on the virtual object; and display, when a target condition for resetting a location of the virtual object is satisfied in the movement process of the virtual object, a process in which the virtual object reappears at the first location, the target condition including at least one of the following: movement duration of the virtual object in the first terrain reaches target duration, and the hit point of the virtual object decreases to a hit point threshold.

In some embodiments, the apparatus further includes a determining module. The determining module is configured to obtain an initial target attribute value of the virtual object and a correlation coefficient of the initial target attribute value when the target condition for resetting the location of the virtual object is satisfied, a value of the correlation coefficient being negatively correlated with a quantity of resetting times of the virtual object, and the initial target attribute value including at least one of the following: an initial hit point and an initial speed value of the virtual object; and multiplying the correlation coefficient and the initial target attribute value to obtain an initial target attribute value when the virtual object reappears at the first location.

In some embodiments, the teleportation module 4552 is further configured to: display, when the virtual object moves from the first location to the exit of the first terrain, a first virtual resource used as a reward, the first virtual resource being configured for use in the first virtual space; and claim the first virtual resource in response to a claiming operation on the first virtual resource, and teleport the virtual object back to the first virtual space.

In some embodiments, the teleportation module 4552 is further configured to: display teleportation prompt information when the virtual object moves from the first location to the exit of the first terrain, the teleportation prompt information being configured for prompting whether to teleport the virtual object back to the first virtual space; and teleport the virtual object back to the first virtual space in response to a teleportation instruction triggered based on the teleportation prompt information.

In some embodiments, the apparatus further includes a sixth control module. The sixth control module is configured to: control the virtual object to move in the first terrain in the second virtual space in response to the movement instruction for the virtual object; and display, when the virtual object moves to a target location in the first terrain, a second virtual resource used as a reward, the second virtual resource being configured for use in the second virtual space.

In some embodiments, the apparatus further includes a second display module. The second display module is configured to display a first virtual object and a second virtual object in the first virtual space in the virtual scene. When both the first virtual object and the second virtual object are teleported to the second virtual space, the apparatus further includes a third display module. The third display module is configured to: display the first virtual object at a third location different from the exit in the second virtual space in the virtual scene, and display the second virtual object at a fourth location different from the exit in the second virtual space in the virtual scene, the third location and the fourth location being different locations, and a distance between the third location and the exit being different from a distance between the fourth location and the exit.

In some embodiments, at least one obstacle is disposed in the first terrain, and the obstacle is configured to hinder the virtual object from moving in the first terrain. The apparatus further includes a fourth display module. The fourth display module is configured to: display task guidance information for an interaction task; control, based on the task guidance information in response to a task execution instruction for the interaction task, the virtual object to perform the interaction task; and undisplay the obstacle included in the first terrain when the virtual object completes the interaction task.

In some embodiments, at least two types of obstacles are disposed in the first terrain, the at least two types of obstacles are configured to hinder the virtual object from moving in the first terrain, and different types of obstacles are associated with different interaction tasks. The apparatus further includes a fifth display module. The fifth display module is configured to: display task guidance information for an interaction task associated with each type of obstacle; control, based on the task guidance information in response to a task execution instruction for a target interaction task, the virtual object to perform the target interaction task; and undisplay, when the virtual object completes the target interaction task, a target type of obstacle associated with the target interaction task in the first terrain.

In some embodiments, the apparatus further includes a sixth display module. The sixth display module is configured to: display, in the first virtual space in the virtual scene, the virtual object and a virtual scene element that belongs to a natural phenomenon; and teleport the virtual object from the first virtual space to the second virtual space when the virtual object is located in a sensing region of the virtual scene element.

In some embodiments, the sixth display module is further configured to: display dwell time of the virtual object in the sensing region when the virtual object is located in the sensing region of the virtual scene element; and teleport the virtual object from the first virtual space to the second virtual space when the dwell time reaches a dwell time threshold.

An embodiment of this application provides a computer program product or a computer program. The computer program product or the computer program includes computer-executable instructions. The computer-executable instructions are stored in a non-transitory computer-readable storage medium. A processor of an electronic device reads the computer-executable instructions from the computer-readable storage medium. The processor executes the computer-executable instructions, so that the electronic device performs the method for interaction in a virtual scene provided in the embodiments of this application.

An embodiment of this application provides a non-transitory computer-readable storage medium, having computer-executable instructions stored therein. The computer-executable instructions, when executed by a processor, cause the processor to perform the method for interaction in a virtual scene provided in the embodiments of this application, for example, the method for interaction in a virtual scene shown in FIG. 3.

In some embodiments, the computer-readable storage medium may be a memory such as a read-only memory (ROM), a random access memory (RAM), an erasable programmable read-only memory (EPROM), an electrically erasable programmable read-only memory (EPROM), a flash memory, a magnetic surface memory, an optical disk, a CD-ROM, or the like, or may be various devices including one or any combination of the foregoing memories.

In some embodiments, the computer-executable instructions may be written in a form of a program, software, a software module, a script, or code in any form of programming language (including compilation or interpretation language, or declarative or procedural language), and may be deployed in any form, including being deployed as an independent program or being deployed as a module, component, subroutine, or another unit suitable for use in a computing environment.

In an example, the computer-executable instructions may, but do not necessarily, correspond to a file in a file system, and may be stored in a part of a file that saves another program or other data, for example, stored in one or more scripts in a HyperText Markup Language (HTML) file, stored in a single file that is specially used for a program in discussion, or stored in a plurality of collaborative files (for example, stored in files of one or more modules, subprograms, or code parts).

In an example, the computer-executable instructions may be deployed to be executed on one electronic device, on a plurality of electronic devices located at one site, or on a plurality of electronic devices distributed at a plurality of locations and connected to each other by using a communication network.

In summary, the embodiments of this application has the following beneficial effects.
(1) When the virtual object is teleported to the second virtual space for the first time, the virtual object is teleported to the first terrain that the second virtual space has, and after the virtual object leaves the second virtual space, when the virtual object is teleported to the second virtual space again, the terrain in the second virtual space is controlled to change from the first terrain to the second terrain, so that the virtual object is teleported to the second terrain that the second virtual space has. In this way, each time the virtual object is teleported to the second virtual space, the terrain that the second virtual space has is dynamically changed. Compared with teleporting the virtual object to a fixed terrain each time, this improves utilization of terrain resources in the virtual scene, thereby improving the efficiency of human-computer interaction and the utilization of the hardware resources of the electronic device.
(2) A plurality of second virtual resources are displayed in the movement process of the virtual object based on a plurality of target distance thresholds. Therefore, enthusiasm of the virtual object about movement and interaction experience are improved.

Relevant data such as a trigger operation is involved in the embodiments of this application. When the embodiments of this application are applied to a specific product or technology, a license or consent of a user is required to be obtained, and collection, use, and processing of the related data are required to comply with related laws and regulations and standards of related countries and regions.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The foregoing descriptions are only an example of this application and are not intended to limit the scope of protection of this application. Any modification, equivalent replacement, or improvement made within the spirit and scope of this application fall within the protection scope of this application.

What is claimed is:

1. A method for interaction in a virtual scene performed by a computer device, the method comprising:
displaying, at a first location in a second virtual space, a virtual object teleported from a first virtual space to the second virtual space, wherein the first location is in a first terrain of the second virtual space and the first location is different from a location of an exit of the first terrain;
teleporting the virtual object back to the first virtual space when the virtual object moves from the first location to the exit of the first terrain;
changing a terrain in the second virtual space from the first terrain to a second terrain when the virtual object is teleported from the first virtual space to the second virtual space again; and
displaying the virtual object at a second location in the second terrain, the second location being different from a location of an exit of the second terrain.

2. The method according to claim 1, wherein the first location is an entrance of the first terrain, and the displaying, at the first location in the second virtual space, the virtual object teleported from the first virtual space to the second virtual space comprises:
presenting, at the entrance in the second virtual space, a process in which the virtual object appears in the second virtual space; and
the teleporting the virtual object back to the first virtual space when the virtual object moves from the first location to the exit of the first terrain comprises:
teleporting the virtual object back to the first virtual space when the virtual object moves from the entrance to the exit of the first terrain.

3. The method according to claim 1, wherein the exit of the first terrain is associated with a plurality of paths, and after the displaying, at the first location in the second virtual space, the virtual object teleported from the first virtual space to the second virtual space, the method further comprises:
in response to a selection operation on a target path among at least two paths when the first location is an intersection location of the at least two paths, controlling the virtual object to enter the target path and move along the target path; and
the teleporting the virtual object back to the first virtual space when the virtual object moves from the first location to the exit of the first terrain comprises:
teleporting the virtual object back to the first virtual space when the virtual object moves to the exit of the first terrain in a movement process of the virtual object along the target path.

4. The method according to claim 1, wherein after the displaying, at the first location in the second virtual space, the virtual object teleported from the first virtual space to the second virtual space, the method further comprises:
controlling the virtual object to move in the first terrain in the second virtual space in response to a movement instruction for the virtual object; and
displaying an obstacle in the movement process of the virtual object, the obstacle being configured to hinder the virtual object from moving in the first terrain.

5. The method according to claim 1, wherein after the displaying, at the first location in the second virtual space, the virtual object teleported from the first virtual space to the second virtual space, the method further comprises:
controlling the virtual object to move in the first terrain in the second virtual space in response to a movement operation on the virtual object; and
displaying, when a target condition for resetting a location of the virtual object is satisfied in the movement process of the virtual object, a process in which the virtual object reappears at the first location,
the target condition comprising at least one of the following: movement duration of the virtual object in the first terrain reaches target duration, and the hit point of the virtual object decreases to a hit point threshold.

6. The method according to claim 1, wherein the teleporting the virtual object back to the first virtual space when the virtual object moves from the first location to the exit of the first terrain comprises:
displaying, when the virtual object moves from the first location to the exit of the first terrain, a first virtual resource used as a reward, the first virtual resource being configured for use in the first virtual space; and
claiming the first virtual resource in response to a claiming operation on the first virtual resource, and teleporting the virtual object back to the first virtual space.

7. The method according to claim 1, wherein the teleporting the virtual object back to the first virtual space when the virtual object moves from the first location to the exit of the first terrain comprises:
displaying teleportation prompt information when the virtual object moves from the first location to the exit of the first terrain, the teleportation prompt information being configured for prompting whether to teleport the virtual object back to the first virtual space; and
teleporting the virtual object back to the first virtual space in response to a teleportation instruction triggered based on the teleportation prompt information.

8. The method according to claim 1, wherein after the displaying, at the first location in the second virtual space, the virtual object teleported from the first virtual space to the second virtual space, the method further comprises:
controlling the virtual object to move in the first terrain in the second virtual space in response to the movement instruction for the virtual object; and
displaying, when the virtual object moves to a target location in the first terrain, a second virtual resource used as a reward, the second virtual resource being configured for use in the second virtual space.

9. The method according to claim 1, wherein before the displaying, at the first location in the second virtual space, the virtual object teleported from the first virtual space to the second virtual space, the method further comprises:
displaying a first virtual object and a second virtual object in the first virtual space; and
when both the first virtual object and the second virtual object are teleported to the second virtual space, the method further comprises:
displaying the first virtual object at a third location different from the exit in the second virtual space, and displaying the second virtual object at a fourth location different from the exit in the second virtual space,
the third location and the fourth location being different locations, and a distance between the third location and the exit being different from a distance between the fourth location and the exit.

10. The method according to claim 1, wherein at least one obstacle is disposed in the first terrain, the obstacle is configured to hinder the virtual object from moving in the first terrain, and the method further comprises:
displaying task guidance information for an interaction task;
controlling, based on the task guidance information in response to a task execution instruction for the interaction task, the virtual object to perform the interaction task; and
removing the obstacle from the first terrain when the virtual object completes the interaction task.

11. The method according to claim 1, wherein at least two types of obstacles are disposed in the first terrain, the at least two types of obstacles are configured to hinder the virtual object from moving in the first terrain, and different types of obstacles are associated with different interaction tasks; and
the method further comprises:
displaying task guidance information for an interaction task associated with each type of obstacle;
controlling, based on the task guidance information in response to a task execution instruction for a target interaction task, the virtual object to perform the target interaction task; and
removing, when the virtual object completes the target interaction task, a target type of obstacle associated with the target interaction task from the first terrain.

12. The method according to claim 1, wherein before the displaying, at the first location in the second virtual space, the virtual object teleported from the first virtual space to the second virtual space, the method further comprises:
displaying, in the first virtual space, the virtual object and a virtual scene element that belongs to a natural phenomenon; and
teleporting the virtual object from the first virtual space to the second virtual space when the virtual object is located in a sensing region of the virtual scene element.

13. An electronic device, comprising:
a memory, configured to store computer-executable instructions; and
a processor, configured to implement a method for interaction a virtual scene when executing the computer-executable instructions stored in the memory, the method including:
displaying, at a first location in a second virtual space, a virtual object teleported from a first virtual space to the second virtual space, wherein the first location is in a first terrain of the second virtual space and the first location is different from a location of an exit of the first terrain;
teleporting the virtual object back to the first virtual space when the virtual object moves from the first location to the exit of the first terrain;
changing a terrain in the second virtual space from the first terrain to a second terrain when the virtual object is teleported from the first virtual space to the second virtual space again; and
displaying the virtual object at a second location in the second terrain, the second location being different from a location of an exit of the second terrain.

14. The electronic device according to claim 13, wherein the first location is an entrance of the first terrain, and the displaying, at the first location in the second virtual space, the virtual object teleported from the first virtual space to the second virtual space comprises:
presenting, at the entrance in the second virtual space, a process in which the virtual object appears in the second virtual space; and
the teleporting the virtual object back to the first virtual space when the virtual object moves from the first location to the exit of the first terrain comprises:
teleporting the virtual object back to the first virtual space when the virtual object moves from the entrance to the exit of the first terrain.

15. The electronic device according to claim 13, wherein the exit of the first terrain is associated with a plurality of paths, and after the displaying, at the first location in the second virtual space, the virtual object teleported from the first virtual space to the second virtual space, the method further comprises:
in response to a selection operation on a target path among at least two paths when the first location is an intersection location of the at least two paths, controlling the virtual object to enter the target path and move along the target path; and
the teleporting the virtual object back to the first virtual space when the virtual object moves from the first location to the exit of the first terrain comprises:
teleporting the virtual object back to the first virtual space when the virtual object moves to the exit of the first terrain in a movement process of the virtual object along the target path.

16. The electronic device according to claim 13, wherein after the displaying, at the first location in the second virtual space, the virtual object teleported from the first virtual space to the second virtual space, the method further comprises:
controlling the virtual object to move in the first terrain in the second virtual space in response to a movement instruction for the virtual object; and
displaying an obstacle in the movement process of the virtual object, the obstacle being configured to hinder the virtual object from moving in the first terrain.

17. The electronic device according to claim 13, wherein after the displaying, at the first location in the second virtual space, the virtual object teleported from the first virtual space to the second virtual space, the method further comprises:
controlling the virtual object to move in the first terrain in the second virtual space in response to a movement operation on the virtual object; and
displaying, when a target condition for resetting a location of the virtual object is satisfied in the movement process of the virtual object, a process in which the virtual object reappears at the first location,
the target condition comprising at least one of the following: movement duration of the virtual object in the first terrain reaches target duration, and the hit point of the virtual object decreases to a hit point threshold.

18. The electronic device according to claim 13, wherein the teleporting the virtual object back to the first virtual space when the virtual object moves from the first location to the exit of the first terrain comprises:
displaying, when the virtual object moves from the first location to the exit of the first terrain, a first virtual resource used as a reward, the first virtual resource being configured for use in the first virtual space; and
claiming the first virtual resource in response to a claiming operation on the first virtual resource, and teleporting the virtual object back to the first virtual space.

19. The electronic device according to claim 13, wherein the teleporting the virtual object back to the first virtual space when the virtual object moves from the first location to the exit of the first terrain comprises:
displaying teleportation prompt information when the virtual object moves from the first location to the exit of the first terrain, the teleportation prompt information being configured for prompting whether to teleport the virtual object back to the first virtual space; and
teleporting the virtual object back to the first virtual space in response to a teleportation instruction triggered based on the teleportation prompt information.

20. A non-transitory computer-readable storage medium, having computer-executable instructions stored therein, the computer-executable instructions, when executed by a processor of a computer device, causing the computer device to implement a method for interaction in a virtual scene including:
displaying, at a first location in a second virtual space, a virtual object teleported from a first virtual space to the second virtual space, wherein the first location is in a first terrain of the second virtual space and the first location is different from a location of an exit of the first terrain;
teleporting the virtual object back to the first virtual space when the virtual object moves from the first location to the exit of the first terrain;
changing a terrain in the second virtual space from the first terrain to a second terrain when the virtual object is teleported from the first virtual space to the second virtual space again; and
displaying the virtual object at a second location in the second terrain, the second location being different from a location of an exit of the second terrain.
